(19) United States
(12) Patent Application Publication
(10) Pub. No.: US 2021/0337433 A1
(43) Pub. Date: Oct. 28, 2021

(54) IMPROVEMENTS IN AND RELATING TO LTE WLAN AGGREGATION

(71) Applicant: SAMSUNG ELECTRONICS CO., LTD., Gyeonggi-do (KR)

(72) Inventors: Gert Jan VAN LIESHOUT, Apeldoorn (NL); VAN DER VELDE Himke, Zwolle (NL); JANG Jaehyuk, Gyeonggi-do (KR); RAJADURAI Rajavelsamy, Bangalore (IN)

(21) Appl. No.: 16/320,351

(22) PCT Filed: Jul. 3, 2017
(86) PCT No.: PCT/KR2017/007029

§ 371 Date: Jan. 24, 2019

(30) Foreign Application Priority Data
Jul. 26, 2016 (GB) 1612923.1

(51) Int. Cl. H04W 36/00; H04W 36/14; H04W 88/06

(52) U.S. Cl. CPC H04W 36/0033; H04W 84/12; H04W 88/06; H04W 36/14

(57) ABSTRACT

Disclosed is a method of managing a reconfiguration in a telecommunications system, wherein a User Equipment UE is connected to a network, comprising the steps of: providing a context identifier in a Protocol Data Unit PDU to indicate a present context at the originator of the PDU; a receiver of the PDU detecting a change in the context identifier and determining a change in the context at the packet originator on the basis of detecting the change.

### TECHNICAL FIELD

The present invention relates to the aggregation, in a 3GPP telecommunication system, of data traffic over LTE and WLAN. In particular, it relates to the situation which exists and intra/inter-eNB change when there is data traffic on the WLAN.

### BACKGROUND ART

In 3GPP systems, it is possible to offload data from LTE to WLAN to free up the, usually, more limited resource offered by LTE. One specific approach is known as LTE-WLAN Aggregation (LWA). LWA poses a problem of how to deal with the situation at handover. In particular, it raises questions of how does the User Equipment (UE) knows when receiving data over the WLAN at around the time of an LTE handover whether it is still ciphered with the old or new key (KeNB). Further, how does the eNB know, when receiving data over WLAN whether it is still ciphered old or new key (KeNB). Other issues are raised, which will be dealt with in the following description.

### DISCLOSURE OF INVENTION

### Technical Problem

FIG. 1 shows a typical network arrangement according to a prior art system, operable under Release 13. This shows the Mobile Management Entity (MME) 100, which is connected via Si interfaces to eNB 110 and eNB 120. Each eNB 110, 120 is connected to two WLAN Terminations (WT) 130, 140. The WTs and eNBs are connected via Xw interfaces.

Release 13 of 3GPP only supports data traffic over WLAN in the downlink direction (i.e. from network to UE). It was deemed not technically feasible to carry data in an uplink direction in that particular release.

FIG. 2 shows the relevant protocol stack, which shows that protocol LWAAP (defined in 36.360), which is used when there is an LWA data bearer. The LWAAP PDU structure is shown in FIG. 3 which shows the addition of a packet header at October 1, which is added to the PDCP PDU (Packet Data Convergence Protocol Data Unit). It acts to identify the Data Radio Bearer (DRB) which the packet belongs to. Based on the received DRB-ID in the packet header, the UE then knows which PDCP entity in the UE to deliver the packet to, noting that the UE has one PDCP entity per DRB.

When PDCP PDUs are carried over WLAN, they are ciphered twice: once on a PDCP level by the eNB using the usual LTE ciphering based on the key KeNB. They are further ciphered on a WLAN level based on the key S-KWT. This key is derived from the KeNB.

In prior art releases, such as Release 13, to limit complexity and to avoid the need to keep track of keys at handover, the LWA configuration is simply released at the point of handover, meaning that the WLAN connection is dropped. This avoids the need to determine when or how to update S-KWT and avoids the need to know which packets transmitted over the WLAN are ciphered with a new key at PDCP level, but means that offloading via WLAN is interrupted.

### Solution to Problem

According to an embodiment of present invention, a method of managing a reconfiguration in a telecommunications system, wherein a User Equipment UE is connected to a network, comprises providing a context identifier in a Protocol Data Unit PDU to indicate a present context at the originator of the PDU, and a receiver of the PDU detecting a change in the context identifier and determining a change in the context at the packet originator on the basis of detecting the change.

According to another embodiment of present invention, an apparatus is arranged to perform the above-mentioned method.

### Advantageous Effects of Invention

It is an aim of embodiments of the present invention to address shortcomings in the prior art and, in particular, to improve connectivity conditions in an LWA situation.

According to the embodiments of present invention, improved connectivity conditions in LWA situation can be achieved.

According to the present invention there is provided an apparatus and method as set forth in the appended claims. Other features of the invention will be apparent from the dependent claims, and the description which follows.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 shows a prior art network configuration;

FIG. 2 shows a protocol stack according to the prior art;

FIG. 3 shows an LWAAP protocol data unit (PDU) according to the prior art;

FIG. 4 shows a representation of Dual Connectivity in the prior art;

FIG. 5 shows a representation of intra-eNB handover according to an embodiment of the present invention; and

FIG. 6 shows a representation of inter-eNB handover according to an embodiment of the present invention.

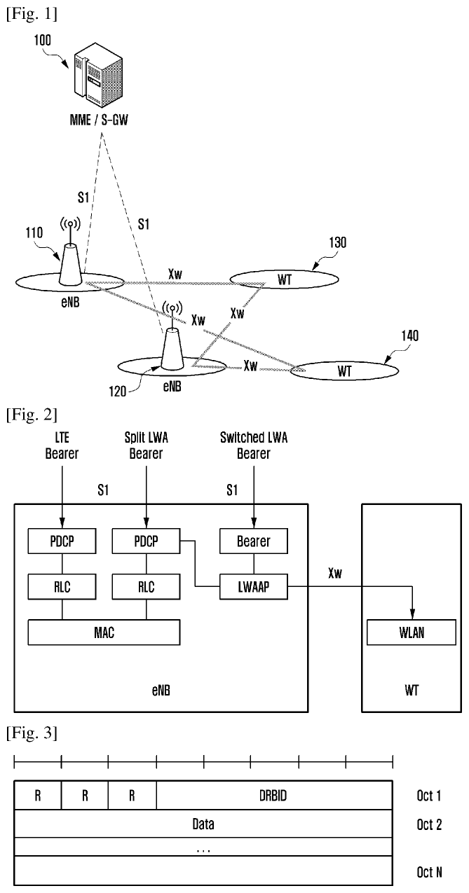

### MODE FOR THE INVENTION

In order to improve connectivity and data transfer capabilities, Release 14 of 3GPP proposes an enhanced LTE-WLAN Aggregation (LWA) which is planned to support uplink data transport over WLAN (this not being possible in previous releases) as well as proposing support for intra- and inter-eNB handover without changing WT. However, there is not presently any defined means to accomplish these aims.

In order to understand how these aims may be accomplished, it is useful to look at certain prior art situations which help to understand embodiments of the present invention which will be described later.

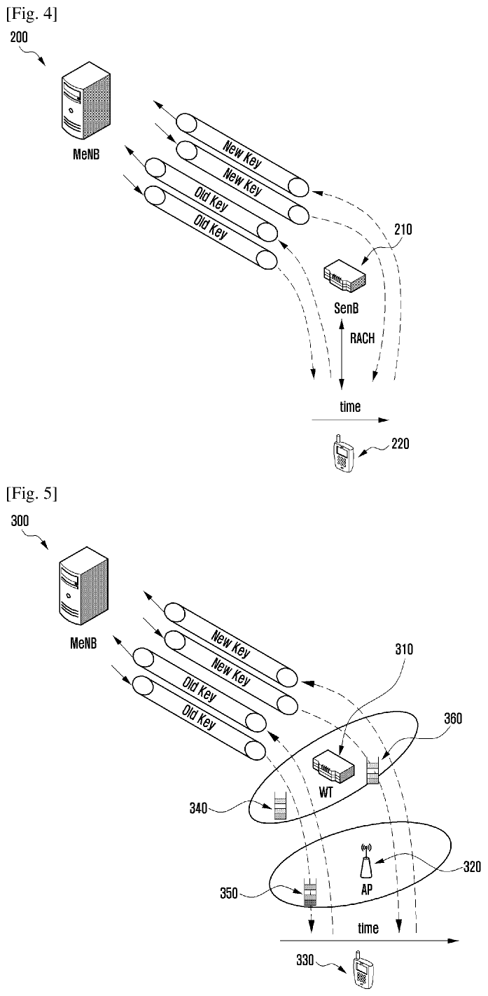

Release 12 included the concept of dual connectivity (DC). This is shown in FIG. 4. This shows Master eNB MeNB 200, Secondary eNB SeNB 210 and UE 220 and the key exchanges that occur during a handover process.

During the handover preparation phase, for one DRB two new GTP (GPRS Tunnelling Protocol) tunnels are created over the X2 interface, one each in uplink and downlink directions. These new tunnels are used solely for transporting data packets ciphered with the new key i.e. the key used after handover.

In the downlink direction, the MeNB 200 sends packets ciphered at the PDCP level with the old key to the SeNB 210, during the handover and using the old key. These packets are then transmitted on to the UE 220 up to the point that the UE 220 performs RACH (Random Access Channel). This has the effect of ending the use of the old key and beginning the use of the new key. After RACH, the SeNB 210 delivers data packets from the new tunnel to the UE 220 which are encrypted using the new key.

In the uplink direction, the SeNB 210 delivers all data packets before RACH to the MeNB 200 via the old tunnel using the old key and, after RACH, using the new tunnel and the new key.

In this case, RACH is crucial in defining a point in time at which the no more packets ciphered with the old key are exchanged in either uplink or downlink directions. From the point that RACH is performed all packets in both directions are ciphered with the new key.

This differs from LWA (as used in Release 13) because there is no RACH procedure in WLAN that can be used as a trigger point to coordinate the change in cipher keys. As such, there is a need to define another mechanism to signal the change from old to new keys.

Due to the technical complexity of coordinating keys, in the prior art, a simple approach was adopted of releasing the WLAN configuration at handover, meaning that the WLAN connection is lost and then may be re-established after handover is concluded.

In order to ensure continuity of WLAN connection during handover, a different approach must be adopted.

FIG. 5 shows an embodiment of the present invention in relation to an intra-eNB handover, which maintains WLAN connection during handover.

In this case, LWA WLAN equipment comprises WT 310 which conforms to 3GPP specifications and a WLAN Access Point 320, which may be an off the shelf product. The interface between WT 310 and AP 320 is currently not standardised by 3GPP.

At the time of handover, some downlink data ciphered by the old key may be buffered in the AP 320 for onward transmission to UE 330. Further downlink data ciphered by the old key may be buffered in the WT 310 for onward transmission to the AP. This is represented by buffers 350 and 340 respectively.

Additionally, if the WT is aware that the security context has changed, then there may also be data buffered in the WT 310 which has been encrypted with the new key.

The following details the PDCP PDU handling during the handover phase.

Packet Discard at the Receiver.

When the UE 330 receives the handover command, the key is changed from the old key to the new key. From that moment, all new uplink PDCP data PDU transmissions will be ciphered with the new key, and the UE can only decipher downlink PDCP data PDU transmissions which have been ciphered with the new key. Any packets received which have been encrypted with the old key can not be deciphered. The UE 330 should be able to identify these packets and discard them. Similarly the eNB 300 should also be able to identify these packets and may discard them. These dropped packets are retransmitted later in the usual way and decrypted using the new key.

Received PDCP data PDUs ciphered with the new key should not be discarded but deciphered and further processed.

Uplink (UL) Traffic Routing

From the moment that the UE switched to a new key (KeNB), the AP 320, the WT 310 and the eNB 300 will start to receive PDCP PDUs encrypted with the new key. If different tunnels are used over the Xw interface, all UL traffic generated by the UE after the handover has to be transported using the new tunnels over Xw i.e. WT 310 shall be able to identify which PDUs were originated by the UE before the handover, and which PDUs were originated by the UE after the handover. This is true for encrypted PDCP data PDUs, but also for unencrypted PDCP control PDUs.

Downlink (DL) Buffered Data Discarding

From the moment the WT 310 is aware of a changed context/key at the UE, the WT 310 may discard any buffered DL data ciphered with the old key 340. This will avoid unnecessary transport over the radio interface towards the UE 330 that would only result in the UE discarding this data.

Embodiments of the present invention provide a mechanism for this determination to be made i.e. which packets have been generated based on the old context (before the handover) and which have been generated based on the new context (after the handover).

One means of achieving this is to introduce information into a PDU header to identify the (security) context used by the originator of the packet (UE 330 or eNB 300) at the time of packet origination. In particular, the data structure shown in FIG. 3 has 3 reserved bits which could be deployed for this purpose. For instance, one or two of these bits may be used to indicate a UE context identification (context_Id). The UE 330 would set the context_Id differently for PDUs transmitted before and after the handover. Similarly, the eNB 300 would set the context_Id differently depending on whether the DL packets were sent to the WT before or after the handover. Note that the context_Id would also indicate the ciphering key used for ciphering a contained PDCP PDU if the PDCP PDU was (partly) ciphered.

In this way, once a change in the security context is identified, then any entity receiving the PDU in question will know that the transmitter has updated its context and is using a new context/key. This will enable the receiver to act as set out above.

Different mechanisms may be used to ensure that the context_Id contains a different value before and after handover, both in uplink PDUs and downlink PDUs. It is important to note that the in order to signal a change in context, then a receiver should be able to detect a change in some value that it has received, The actual absolute value is not important, but the fact that it has changed is what is used to signal a change in context.

The following describes three specific mechanisms.

In a first embodiment, the Context-Id may be incremented by 1 at every security related update by both UE 330 and eNB 300 (eNB 300 informs WT 310).

By using at least one, and preferably two, of the reserved bits RRR in the data structure of the LWAAP PDU data structure of FIG. 3, it is possible to indicate a change in the security context. By the use of two bits, a change may be indicated by cycling through the values 00, 01, 10 and 11. By the use of two bits, it is less likely that a change in context might be accidentally missed in the case of two rapid handovers, where a single reserved bit might change from 0 to 1 and back to 0 again.

In a second embodiment, eNB may explicitly configure UE 330/WT 310 with the new contex_Id value to use after a certain reconfiguration. In contrast to the first embodiment above, the context_Id value is explicitly determined by the eNB, rather than simply cycling through a sequence.

In a third embodiment, eNB 300 may implicitly configure the UE 330/WT 310 with the new contex_Id value to use after a certain reconfiguration. For instance. the value may be determined based on the LSB's of some other parameter (e.g. the WT counter). The WT counter represents a good option for this as its value is passed between the entities at handover in any event.

Implementation of these specific mechanisms may be achieved by means of the RRC message which is exchanged at the time of handover. This message includes many parameters and may be adapted, if required, to specifically configure the context-Id as per the second embodiment above.

In summary, embodiments of the present invention are arranged to provide a means by which it is possible to sense handover and allow continuous connection by both WLAN and LTE in an LWA scenario.

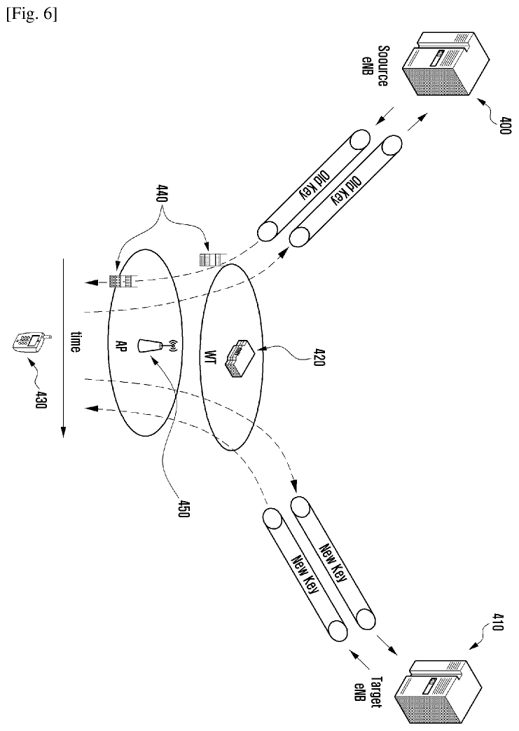

FIG. 6 shows a representation of an inter-eNB handover according to an embodiment of the present invention. This is similar to the scenario set out in relation to the intra-eNB situation described in FIG. 5. Handover is represented between Source eNB 400 and Target eNB 410, whilst maintaining connection via WT 420, connected to Access point AP 450. The UE 430 experiences continuous connection via LWA to LTE and WLAN connections.

During the handover preparation phase, two new GTP (GPRS Tunnelling Protocol) tunnels are created over the X2 interface, one each in uplink and downlink directions between the Source eNB and the WT 420. Data packets, encrypted using the old key are transmitted and buffered by the WT for onward transmission to the UE 430. The buffering is indicated by 440, showing that buffering is performed both at the WT 420 and at the AP 450.

Also for this inter-eNB handover case the functionality of “Packet discard at the receiver”, “UL traffic routing” and “DL buffered data discarding” is enabled, as previously described. Note that for “UL traffic routing”, when the UE 330 receives the handover command, in the inter-eNB handover case all communication between UE and eNB takes place with the new eNB (420) i.e. using the new tunnels over Xw. For this, again the WT 310 shall be able to identify which PDUs were originated by the UE before the handover, and which PDUs were originated by the UE after the handover. This is true for encrypted PDCP data PDUs, but also for unencrypted PDCP control PDUs.

In order to signal that there is a change in the security context or, in other words that the cipher key has changed, there are a several possible means of achieving this. These are identical with those described in relation to FIG. 5, previously.

Upon receiving notification that the security context has changed, either the WT 420 or the UE 430 drops any unencrypted data packets in the buffer 440. These dropped packet can be recovered in the usual way later and decrypted using the new key.

The new key is then used for all future communication in both uplink and downlink directions between the UE and the Target eNB 410.

Throughout this application, reference is made to a handover. However, the skilled person will appreciate that there are other situations in which a context, specifically a security context, may change and the term ‘reconfiguration’ is used to indicate this. A handover is only one example of such a reconfiguration.

More generally, embodiments of the invention are able to detect a change in context by means of the change in context identifier and this can be used to adapt the behaviour of one or more connected identities accordingly. Specific examples disclosed herein refer to handover, but other forms of reconfiguration relating to other changes of context will be apparent to the skilled person.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-12. (canceled)

13. A method for supporting an LTE-WLAN aggregation (LWA) by a base station in a wireless communication system, the method comprising:
generating a first security key for a connection between a terminal and a WLAN termination (WT), the terminal being connected to the base station and the WT for the LWA;
transmitting, to the WT, the first security key; and
transmitting, to the terminal, a counter value for generating a second security key.

14. The method of claim 13, wherein the counter value indicates a change in a security context between the terminal and the base station.

15. The method of claim 13, wherein the counter value is monotonically incremented for every new computation of a security key.

16. The method of claim 13, wherein the first security key is generated based on a reconfiguration of the connection between the terminal and the WT.

17. The method of claim 13, wherein at least one data packet transmitted to the terminal with the second security key is discarded after a transmission of a packet with an end marker.

18. A base station for supporting an LTE-WLAN aggregation (LWA) in a wireless communication system, the base station comprising:
a transceiver configured to transmit and receive a signal; and
a controller configured to:
generate a first security key for a connection between a terminal and a WLAN termination (WT), the terminal being connected to the base station and the WT for the LWA,
transmit, to the WT, the first security key, and
transmit, to the terminal, a counter value for generating a second security key.

19. The base station of claim 18, wherein the counter value indicates a change in a security context between the terminal and the base station.

20. The base station of claim 18, wherein the counter value is monotonically incremented for every new computation of a security key.

21. The base station of claim 18, wherein the first security key is generated based on a reconfiguration of the connection between the terminal and the WT.

22. The base station of claim 18, wherein at least one data packet transmitted to the terminal with the second security key is discarded after a transmission of a packet with an end marker.

23. A method for supporting an LTE-WLAN aggregation (LWA) by a terminal in a wireless communication system, the method comprising:
generating a first security key for a connection between the terminal and a WLAN termination (WT), the terminal being connected to a base station and the WT for the LWA;
receiving, from the base station, a counter value for generating a second security key; and
generating the second security key for the connection.

24. The method of claim 23, wherein the counter value indicates a change in a security context between the terminal and the base station.

25. The method of claim 23, wherein the counter value is monotonically incremented for every new computation of a security key.

26. The method of claim 23, wherein the first security key is generated based on a reconfiguration of the connection between the terminal and the WT.

27. The method of claim 23, wherein at least one data packet received from the base station with the second security key is discarded after reception of a packet with an end marker.

28. A terminal for supporting an LTE-WLAN aggregation (LWA) in a wireless communication system, the terminal comprising:
a transceiver configured to transmit and receive a signal; and
a controller configured to:
generate a first security key for a connection between the terminal and a WLAN termination (WT), the terminal being connected to a base station and the WT for the LWA;
receive, from the base station, a counter value for generating a second security key; and
generate the second security key for the connection.

29. The terminal of claim 28, wherein the counter value indicates a change in a security context between the terminal and the base station.

30. The terminal of claim 28, wherein the counter value is monotonically incremented for every new computation of a security key.

31. The terminal of claim 28, wherein the first security key is generated based on a reconfiguration of the connection between the terminal and the WT.

32. The terminal of claim 28, wherein at least one data packet received from the base station with the second security key is discarded after reception of a packet with an end marker.
